(19) United States
(12) Patent Application Publication
(10) Pub. No.: US 2006/0129560 A1
(43) Pub. Date: Jun. 15, 2006

(54) Architecture for enabling business components to access middleware application programming interfaces (APIs) in a runtime environment

(76) Inventors: Greg D. Adams, Dunrobin (CA); Michael Beisiegel, Poughkeepsie, NY (US); Stephen Andrew Brodsky, Los Gatos, CA (US); Jean-Sebastien Michel Delfino, San Carlos, CA (US); Donald F. Ferguson, Yorktown Heights, NY (US); Robert H. High JR., Round Rock, TX (US); Jason Robert McGee, Apex, NC (US); Martin Paul Nally, Laguna Beach, CA (US); Peter David Niblett, Whitchurch (GB); Marc-Thomas Schmidt, Southampton (GB)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/013,884

(22) Filed: Dec. 15, 2004

(51) Int. Cl. G06F 17/30

(52) U.S. Cl. 707/10

(57) ABSTRACT

Provided is an architecture for enabling business components to access middleware components in a runtime environment. A business container hosts business components and services to enable communication between the business components. A plurality of infrastructure components expose interfaces and methods to the business components, wherein the exposed interfaces and methods have names descriptive of a business domain for which the business applications are written. The infrastructure components implementation of the interfaces and methods exposed to the business components include calls to the middleware application programming interfaces (APIs) to invoke middleware APIs to cause middleware operations.

### BACKGROUND OF THE INVENTION

1. Field of the Invention

The present invention relates to an architecture for enabling business components to access middleware APIs in a runtime environment.

2. Description of the Related Art

Software developers often want to integrate business applications with various business services, such as web services, legacy applications, databases, Enterprise Information Systems (EIS), etc. One solution is the J2EE Connector Architecture, part of Java 2 Platform, Enterprise Edition (J2EE) 1.3, that specifies a standard architecture for accessing resources in diverse Enterprise Information Systems (EIS). The J2EE platform provides a reusable component model, using Enterprise JavaBeans and JavaServer Pages technologies to build and deploy multi-tier applications-that are platform and vendor-independent. (Java, J2EE, Enterprise JavaBeans, and JavaServer Pages are trademarks of Sun Microsystems, Inc.).

An Enterprise Java Bean (EJB) is a collection of Java classes, following defined rules and providing specific call-back methods, and an XML file, combined into one single unit. Session beans model business services and expose EJB remote interfaces, which a client will use to invoke the services.

Oftentimes the developer of the business components or applications may not have detailed knowledge of the many application programming interfaces (APIs) needed to access the middleware layer components, including components such as database access components, messaging components, web service components, EJB, etc. Nonetheless, the developers of the business applications will have to spend considerable amounts of time to determine how to properly invoke the middleware layer from the business applications, which can be complex and technical.

### SUMMARY

Provided is an architecture for enabling business components to access middleware APIs in a runtime environment. A business container hosts business components and services to enable communication between the business components. A plurality of infrastructure components expose interfaces and methods to the business components, wherein the exposed interfaces and methods have names descriptive of a business domain for which the business applications are written. The infrastructure components implementation of the interfaces and methods exposed to the business components include calls to the middleware application programming interfaces (APIs) to invoke middleware APIs to cause middleware operations.

### BRIEF DESCRIPTION OF THE DRAWINGS

FIG. 1 illustrates an embodiment of a computing environment.

FIGS. 2 and 3 illustrate operations to design components to implement business applications.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

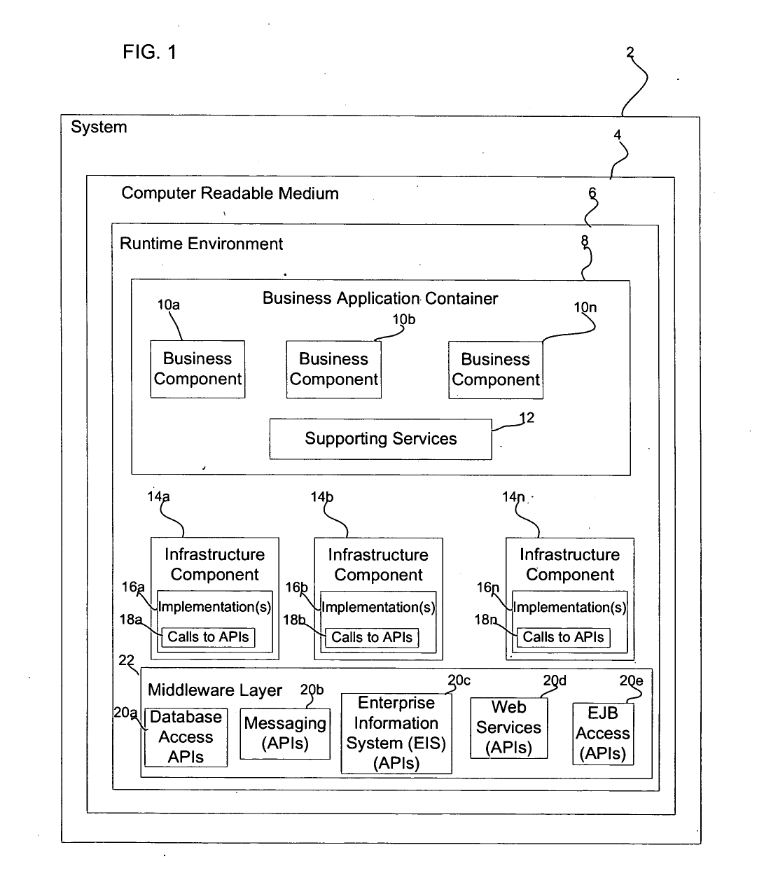

FIG. 1 illustrates a computing environment comprising a computer system 2 having a computer readable medium 4, comprising a volatile or non-volatile storage or memory. The computer readable medium 4 may comprise a memory device in which the described components are implemented and executed. The computer readable medium 4 includes a runtime environment 6 providing the overall runtime environment, such as the J2EE server, in which components and other containers run. The runtime environment 6 includes a business container 8 providing business components 10a, 10b . . . 10n and supporting services 12 that allow the business components 10a, 10b . . . 10n to run and call each other. The supporting services 12 may include life cycle management, security, deployment and component-specific services for the business components 10a, 10b . . . 10n.

A plurality of infrastructure, components 14a, 14b . . . 14n each include one or more implementations 16a, 16b . . . 16n, where each implementation 16a, 16b . . . 16n includes calls to application programming interfaces (APIs) 18a, 18b . . . 18n that are implemented in the middleware layer 22. The infrastructure components 14a, 14b . . . 14n may expose interfaces to the business components 10a, 10b . . . 10n that provide methods used to access the infrastructure component implementations 16a, 16b . . . 16n. The implementations 16a, 16b . . . 16n that may be invoked by the business components 10a, 10b . . . 10n include application programming interfaces (APIs) 18a, 18b . . . 18n to call the middleware APIs 20a, 20b, 20c, 20d, and 20e in a middleware layer 22. The middleware APIs may include: database access APIs 20a to provide access to a database; messaging APIs 20b, such as a Java Message Service (JMS), that allows communication with other entities; Enterprise Information System (EIS) APIs 20c that interface with EIS software and includes enterprise infrastructure systems such as enterprise resource planning (ERP), mainframe transaction processing, database systems, and other legacy information systems; web service APIs 20d providing access to services over the internet; and Enterprise JavaBeans (EJB) access APIs 20e. These APIs 20a, 20b, 20c, 20d, and 20e may be in their own containers. The variable “n” indicates an integer number of instances of an element, and may take different values when used with different elements, such that 10n, 14n, 16n, and 18n may indicate a same or different number of instances of the business components, infrastructure components, implementations, and calls to APIs, respectively.

In one embodiment, the business container 8 provides a runtime environment for the business components 10a, 10b . . . 10n that operates within the general runtime environment 6. The business components 10a, 10b . . . 10n include methods and themselves expose interfaces and methods to each other that have names, i.e., declarations descriptive of a business domain to which the business components are directed, such as financial services, retail operations, industrial operations, etc. The infrastructure components 14a, 14b . . . 14n expose interfaces and methods to the business components 10a, 10b . . . 10n that have names and declarations descriptive of the business domain of the business components 10a, 10b . . . 10n that invoke the implementations 16a, 16b . . . 16n of the infrastructure components 14a, 14b . . . 14n. The implementations 16a, 16b . . . 16n of the infrastructure components 14a, 14b . . . 14n include calls to middleware APIs 18a, 18b . . . 18n to invoke the middleware APIs 20a, 20b . . . 20e on behalf of the business components 10a, 10b . . . 10n. The middleware APIs 20a, 20b . . . 20e may be included in middleware containers. In this way, those developing and coding the business components 10a, 10b . . . 10n may use methods and interfaces having names and declarations descriptive of the business domain in which they are operating to access the middleware components 20a, 20b . . . 20n through the infrastructure components 14a, 14b . . . 14n.

The developers of the business components 10a, 10b . . . 10n need no knowledge of the APIs of the middleware components 20a, 20b . . . 20e, which may be technical and complex, and need only focus on the business domain in which they are operating. For instance, to access data, such as a stock quote, the infrastructure component 14a, 14b . . . 14n may expose an interface having a name descriptive of the business domain, e.g., getStockQuote( ). However, the calls to the APIs. 18a, 18b . . . 18n in the implementations 16a, 16b. . . . 16n may invoke the specific technical APIs to access a database 20a or web service 20d to obtain the requested data. The developer of the business components 10a, 10b . . . 10n does not need to be concerned with how the requested data is obtained, e.g., a database access 20a, web service 20c, etc., but only needs to use the interface whose name is descriptive of the operation as understood in the business domain, e.g., getStockQuote( ). The developers of the infrastructure components 14a, 14b . . . 14n have knowledge of how the middleware APIs 20a, 20b . . . 20e may be used and invoked to provide the access of the middleware layer 22 on behalf of the business components 10a, 10b . . . 10n.

Moreover, the business components 10a, 10b . . . 10n may only call methods implemented in the business application container 8 and may not include any calls to services available in the runtime environment 6 outside the business application container 8. In this way, the business component developer only needs knowledge of the interfaces descriptive of the business domain and not the technical details of the runtime environment 6, such as the middleware APIs 20a, 20b . . . 20e, which may be complex and require detailed knowledge of the different middleware components, such as J2EE and EJB, as well as the database and web service APIs.

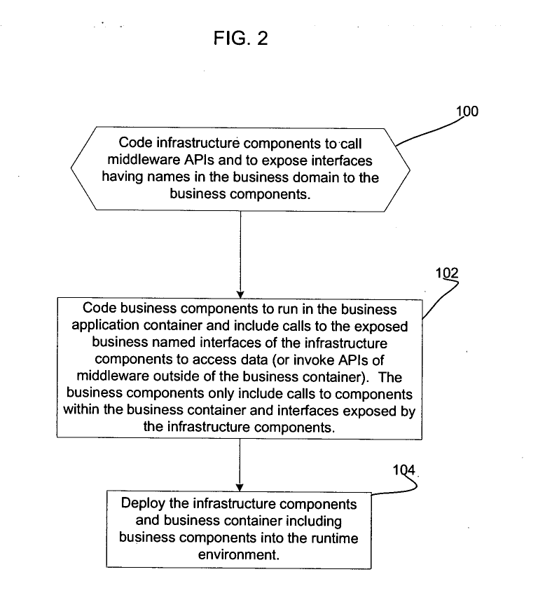

FIG. 2 illustrates operations performed by a developer of the components described in FIG. 1. At block 100, the system oriented developer codes the infrastructure components 14a, 14b . . . 14n to include one or more implementations 16a, 16b . . . 16n having calls to the middleware APIs 18a, 18b . . . . 18n and to expose interfaces having names descriptive of the business domain to which the business components 10a, 10b . . . 10n are directed. The interfaces exposed to the business components 10a, 10b . . . 10n having names and declarations descriptive of the business domain invoke the implementations 16a, 16b . . . 16n including the calls to the middleware APIs 18a, 18b . . . 18n to access the middleware functions. Each infrastructure component 14a, 14b . . . 14n may perform a different one or more operations with respect to one of the middleware APIs 20a, 20b . . . 20e. For instance, one middleware component may be used to access the database access API 20a and another infrastructure component one of the middleware components 20b, 20 . . . . . . 20e. Further, different infrastructure components 14a, 14b . . . 14n may perform different operations with respect to the same middleware component 20a, 20b . . . 20e. Yet further, one infrastructure component may call APIs with respect to different middleware applications 20a, 20b . . . 20e.

Business level developers develop and code (at block 102) business components 10a, 10b . . . 10n to run in the business application container 8 and include calls to the exposed interfaces, descriptive of the business domain, of the infrastructure components 14a, 14b . . . 14n to access data (or access services of middleware outside of the business container 10). The business components 10a, 10b . . . 10n may only include calls to services within the business container 8 and interfaces exposed by the infrastructure components 10a, 10b . . . 10n. The developed infrastructure components 14a, 14b . . . 14n and business application container 8 including business components 10a, 10b . . . 10n are deployed into the runtime environment 8.

In certain situations, the developer may want to change the middleware API 20a, 20b . . . 20e used to perform operations. For instance, the developer may want a business component 10a, 10b . . . 10n to access data from the web service API 20d instead of the database access API 20a. At block 150, the developer may decide to use different middleware APIs 20a, 20b . . . 20e to access data requested by the business components 10a, 10b . . . 10n. To accomplish this, those working on the infrastructure components 14a, 14b . . . 14n, may code (at block 152) infrastructure components 14a, 14b . . . 14n to maintain the same named interfaces exposed to the business components 10a, 10b . . . 10n, descriptive of the business domain, but create new infrastructure components 14a, 14b . . . 14n or modify the existing infrastructure components 14a, 14b . . . 14n to include calls to the new middleware APIs that will be used to access the data (or access middleware APIs outside of the business application container 8). The newly coded or modified infrastructure components 14a, 14b . . . 14n may then be deployed (at block 154) in the runtime environment 6 to be available to calls from the business components 10a, 10b . . . 10n and to invoke the new (second) set of middleware APIs 20a, 20b . . . 20n to perform operations previously performed by a previous (first set) of middleware APIs 20a, 20b . . . 20e, such as access data or perform other middleware operations.

The described embodiments thus provide a way to separate the types of operations and calls into different layers, such as a business layer and infrastructure layer, so that developers of the business components need not be concerned with the details of how the calls, which are descriptive of the business domain, to the infrastructure components to obtain data are implemented.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

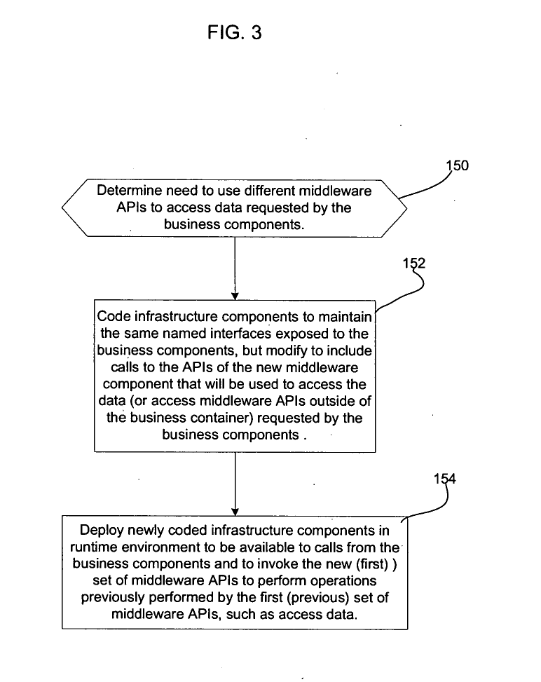

The illustrated operations of FIGS. 2 and 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
providing a business container hosting business components and services to enable communication between the business components;
providing a plurality of infrastructure components, wherein the infrastructure components expose interfaces and methods to the business components, wherein the exposed interfaces and methods have names descriptive of a business domain for which the business applications are written; and
providing middleware application programming interfaces (APIs), wherein the infrastructure components implementation of the interfaces and methods exposed to the business components include calls to the middleware APIs to invoke middleware APIs to cause middleware operations.

2. The method of claim 1, further comprising:
providing at least one middleware container, wherein at least one middleware API invoked by the infrastructure components executes in the middleware container.

3. The method of claim 1, wherein the business components access the middleware APIs through the infrastructure components, and wherein the business components do not include any direct calls to the middleware APIs.

4. The method of claim 1, wherein the business container, infrastructure components, and middleware APIs all execute in a runtime environment, and wherein the business container provides a runtime environment for the business components.

5. The method of claim 4, wherein the business components do not directly call any services and interfaces outside of the business container, wherein the business components call infrastructure components, and wherein the called infrastructure components call middleware APIs and other services in the runtime environment external to the business container.

6. The method of claim 1, wherein the business components include calls to the infrastructure components to access data from a first middleware API, further comprising:
selecting a second middleware API from which to access the data requested by the business component;
coding the infrastructure components to include calls to the selected second middleware APIs to access the data on behalf of the business components previously accessed through the first middleware API, wherein the names of the interfaces used to invoke the infrastructure components to call the second middleware API are the names of the interfaces use to call the infrastructure component to interact with the first middleware API.

7. The method of claim 1, wherein the business components include calls to the infrastructure components to access a first set of middleware APIs external to the business container, further comprising:
selecting a second set of middleware APIs to perform operations for the business components that are currently performed by a first set of middleware APIs; and
coding the infrastructure components to include calls to the second set of middleware APIs to perform the operations requested by the business components previously performed by the first set of middleware APIs, wherein the names of the interfaces called by the business components to invoke the infrastructure components to call the second set of middleware APIs are the same names used to invoke the infrastructure components to call the first set of middleware APIs.

8. A system, comprising:
a processor;
a computer readable medium accessible to the processor and including: 0
(i) a business container hosting business components and services to enable communication between the business components;
(ii) a plurality of infrastructure components, wherein the infrastructure components expose interfaces and methods to the business components, wherein the exposed interfaces and methods have names descriptive of a business domain for which the business applications are written; and
(iii) middleware application programming interfaces (APIs), wherein the infrastructure components implementation of the interfaces and methods exposed to the business components include calls to the middleware APIs to invoke middleware APIs to cause middleware operations.

9. The system of claim 8, wherein the computer readable medium further includes:
at least one middleware container, wherein at least one middleware API invoked by the infrastructure components executes in the middleware container.

10. The system of claim 8, wherein the business components access the middleware APIs through the infrastructure components, and wherein the business components do not include any direct calls to the middleware APIs.

11. The system of claim 8, wherein the business container, infrastructure components, and middleware APIs all execute in a runtime environment executed by the processor, and wherein the business container provides a runtime environment executed by the processor for the business components.

12. The system of claim 11, wherein the business components do not directly call any services and interfaces outside of the business container, wherein the business components call infrastructure components, and wherein the called infrastructure components call middleware APIs and other services in the runtime environment external to the business container.

13. The system of claim 8, wherein the business components include calls to the infrastructure components to access data from a first middleware API, wherein a developer services the code by performing operations comprising:
selecting a second middleware API from which to access the data requested by the business component;
coding the infrastructure components to include calls to the selected second middleware APIs to access the data on behalf of the business components previously accessed through the first middleware API, wherein the names of the interfaces used to invoke the infrastructure components to call the second middleware API are the names of the interfaces use to call the infrastructure component to interact with the first middleware API.

14. The system of claim 8, wherein the business components include calls to the infrastructure components to access a first set of middleware APIs external to the business container, wherein a developer services the code by performing operations comprising:
selecting a second set of middleware APIs to perform operations for the business components that are currently performed by a first set of middleware APIs; and
coding the infrastructure components to include calls to the second set of middleware APIs to perform the operations requested by the business components previously performed by the first set of middleware APIs, wherein the names of the interfaces called by the business components to invoke the infrastructure components to call the second set of middleware APIs are the same names used to invoke the infrastructure components to call the first set of middleware APIs.

15. An article of manufacture including code capable of causing operations to be performed, the operations comprising:
providing a business container hosting business components and services to enable communication between the business components;
providing a plurality of infrastructure components, wherein the infrastructure components expose interfaces and methods to the business components, wherein the exposed interfaces and methods have names descriptive of a business domain for which the business applications are written; and
providing middleware application programming interfaces (APIs), wherein the infrastructure components. implementation of the interfaces and methods exposed to the business components include calls to the middleware APIs to invoke middleware APIs to cause middleware operations.

16. The article of manufacture of claim 15, wherein the operations further comprise:
providing at least one middleware container, wherein at least one middleware API invoked by the infrastructure components executes in the middleware container.

17. The article of manufacture of claim 15, wherein the business components access the middleware APIs through the infrastructure components, and wherein the business components do not include any direct calls to the middleware APIs.

18. The article of manufacture of claim 15, wherein the business container, infrastructure components, and middleware APIs all execute in a runtime environment, and wherein the business container provides a runtime environment for the business components.

19. The article of manufacture of claim 18, wherein the business components do not directly call any services and interfaces outside of the business container, wherein the business components call infrastructure components, and wherein the called infrastructure components call middleware APIs and other services in the runtime environment external to the business container.

20. The article of manufacture of claim 15, wherein the business components include calls to the infrastructure components to access data from a first middleware API, wherein a developer services the code by performing operations comprising:
selecting a second middleware API from which to access the data requested by the business component;
coding the infrastructure components to include calls to the selected second middleware APIs to access the data on behalf of the business components previously accessed through the first middleware API, wherein the names of the interfaces used to invoke the infrastructure components to call the second middleware API are the names of the interfaces use to call the infrastructure component to interact with the first middleware API.

21. The article of manufacture of claim 15, wherein the business components include calls to the infrastructure components to access a first set of middleware APIs external to the business container, wherein a developer services the code by performing operations comprising:
selecting a second set of middleware APIs to perform operations for the business components that are currently performed by a first set of middleware APIs; and
coding the infrastructure components to include calls to the second set of middleware APIs to perform the operations requested by the business components previously performed by the first set of middleware APIs, wherein the names of the interfaces called by the business components to invoke the infrastructure components to call the second set of middleware APIs are the same names used to invoke the infrastructure components to call the first set of middleware APIs.
